(19) United States
(12) Patent Application Publication
(10) Pub. No.: US 2009/0183591 A1
(43) Pub. Date: Jul. 23, 2009

(54) HAND GRIP WITH HALF-SHELLS

(75) Inventor: Mark Jesse, Hamburg (DE)

Correspondence Address: KELLY LOWRY & KELLEY, LLP, 6320 CANOGA AVENUE, SUITE 1650, WOODLAND HILLS, CA, 91367, US

(73) Assignee: DOLMAR GMBH, Hamburg (DE)

(21) Appl. No.: 12/355,969

(22) Filed: Jan. 19, 2009

(30) Foreign Application Priority Data
Jan. 21, 2008 (DE) 20 2008 000 882.4

(51) Int. Cl. A01D 1/14; B25G 1/00

(52) U.S. Cl. 74/551.9; 16/421; 56/10.8

(57) ABSTRACT

A hand grip with half-shells is constructed so as to be able to be fastened to a tubular pipe, and is provided with a mounting opening for the tubular pipe which on the one hand is securely fastened to the tube and on the other hand does not have any intrusive bores in the grip region, in which there is to be a generous space available for a grip mechanism. Each half-shell is provided with a holding arrangement corresponding to the tubular pipe, so that the two holding arrangements form a form-fitting mounting for the respective half-shell on the tubular pipe.

The invention relates to a hand grip with half-shells, which is constructed so as to be able to be fastened to a tubular pipe and is provided with a mounting opening for the tubular pipe, in particular for use for a scythe.

In known scythes, which are provided with a so-called U-handlebar, grip shells are constructed so that they surround a grip tube over their entire length. This is necessary, because the grip shells are exposed to high stresses. The grip shells, constructed as half-shells, are thus prevented from moving apart when a high stress acts upon the half-shells. The tube piece projecting far into the handle takes up a large amount of space, however, so that only a very space-saving grip mechanism can be used.

It is known in addition to construct the hand grip so that the tube dips up to a half into the hand grip. A corresponding clamping area or a corresponding clamping region is, however, correspondingly smaller in this solution. Thereby, the grip mechanism can be increased in size accordingly. However, this brings it about that the half-shells or clamping shells can move apart upon a stressing in a front region of the grip and in its centre. In order to prevent a spreading apart of the half-shells, a screw is used which connects the two half-shells with each other there. However, this solution has the disadvantage that in the grip region a bore is present for the screw, which has an intrusive effect for the user.

The invention is based on the problem of providing a hand grip with half-shells of the said type, which on the one hand is fastened securely to the tube and on the other hand has no intrusive bores in the grip region, with a generous space to be available for a grip mechanism.

This problem is solved by a hand grip with the features of Claim 1.

In particular, provision is made here that each half-shell is provided with a holding arrangement corresponding to the tubular pipe, so that each half-shell is provided with a holding arrangement corresponding to the tubular pipe, so that both holding arrangements form a form-fitting mounting for the respective half-shell on the tubular pipe.

Further advantageous developments of the invention are characterized in the sub-claims.

Through the invention, in a simple manner the half-shells are prevented from being able to open at high forces, although the tube end can terminate approximately in the centre of the grips. The grip region can be provided so as to be continuous, i.e. without bores or suchlike, which is felt to be very comfortable when the scythe is being used. Because the clamping area or the clamping region can offer a very large amount of space, a robust grip mechanism can be arranged on the grip.

Furthermore, the solution according to the invention can be converted at a very favourable cost, because it does not require any additional installation parts and installation steps.

In an advantageous further development of the hand grip according to the invention, provision is made that on the two half-shells respectively at least one engagement piece is arranged as a holding arrangement, which engages into the tube interior of the tubular pipe and after the insertion of the tubular pipe up to a stop is caught with the tubular pipe such that both grip halves are pressed against each other and form a form-fitting connection. An installation is therefore very simple. Both grip halves can be joined together, with the grip being able to be subsequently pushed onto the tubular pipe. Through this installation movement, a fixing on the tube is brought about automatically. Additional installation steps for the introduction of a screw and for the screwing thereof are not necessary.

It is particularly advantageous when both half-shells are connected with each other by means of a hinge joint, so that they can be swivelled to each other and folded on each other. Suitable grip halves are immediately available via the hinge joint, which further shortens the installation time. Preferably, the joint is arranged on the grip head. Thereby, the half-shells are, moreover, additionally held together at the head end, which produces a secure connection between tubular pipe and grip.

The production of such a hinge connection and of both grip halves can be converted at a favourable cost, when the hinge joint is constructed as a film hinge and both half-shells are connected in one piece with each other by the film hinge, in particular are produced from a single plastic injection process.

In a further advantageous embodiment of the invention, each holding arrangement is constructed as an engagement hook comprising at least one barb, which engagement hook engages into a corresponding tube opening on the tubular pipe, such that when the half-shells are pushed onto the tubular pipe or when the tubular pipe is pushed into the half-shells, the latter engage so that a secure connection is provided, which can only be released when the barbs are released mechanically out of the corresponding tube opening. After the tubular pipe is placed on the handle, it can no longer become unintentionally released. Nevertheless, a dismantling is possible when the barbs are pressed back. This can be achieved with an auxiliary tool or with a current tool which can be introduced from the head side of the grip. Alternatively, a dismantling can take place by a relatively high tractive force. Here, it can even be accepted that the barbs are destroyed in so doing. As an exchange of the grip is only expedient when the latter or its mechanism is defective, the damage to the barbs is not relevant.

It is favourable that each holding arrangement is constructed substantially as an L-shaped shaped part projecting from an inner surface of the corresponding half-shell. In particular, each holding arrangement consists of two parallel L-shaped legs, which are bridged at their end with a connecting cross-piece, so that at a front end of the legs a U-section is present. This construction offers the advantage that on the one hand an injection moulding process is able to be used, and on the other hand, through the front connecting cross-piece, a large detent surface or a large detent attachment is present, with the two legs, connected rigidly with each other, bringing about a robust construction.

Expediently in the vicinity of the mounting opening and/or in the head region at least one connecting screw is present, connecting the two half-shells and penetrating through a corresponding tube bore. Such a screw does not have an intrusive effect on the user, because it lies outside the grip region. The connection between grip and pipe is thereby very stable.

An application of the invention for a grip with a grip mechanism arranged in a clamping area for operating a motor tool, in particular a motor scythe, is very advantageous, because the pipe of a U-handlebar only has to reach up to the centre of the grip and the remaining space which is gained between the grip head and the pipe is available for mechanical elements.

An example embodiment is described in further detail with the aid of the drawings, with further advantageous further developments of the invention and advantages thereof being described, there being shown purely diagrammatically:

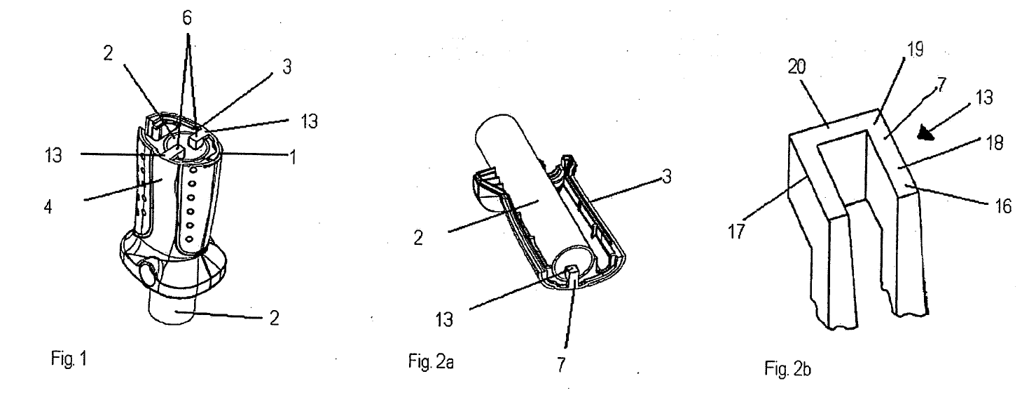

FIG. 1 a perspective illustration of a holding arrangement according to the invention with two barbs of a hand grip for a scythe,

FIG. 2a an illustration of the holding arrangement from a different angle of view, in which only one barb and one half-shell are illustrated,

FIG. 2b an illustration of the barb,

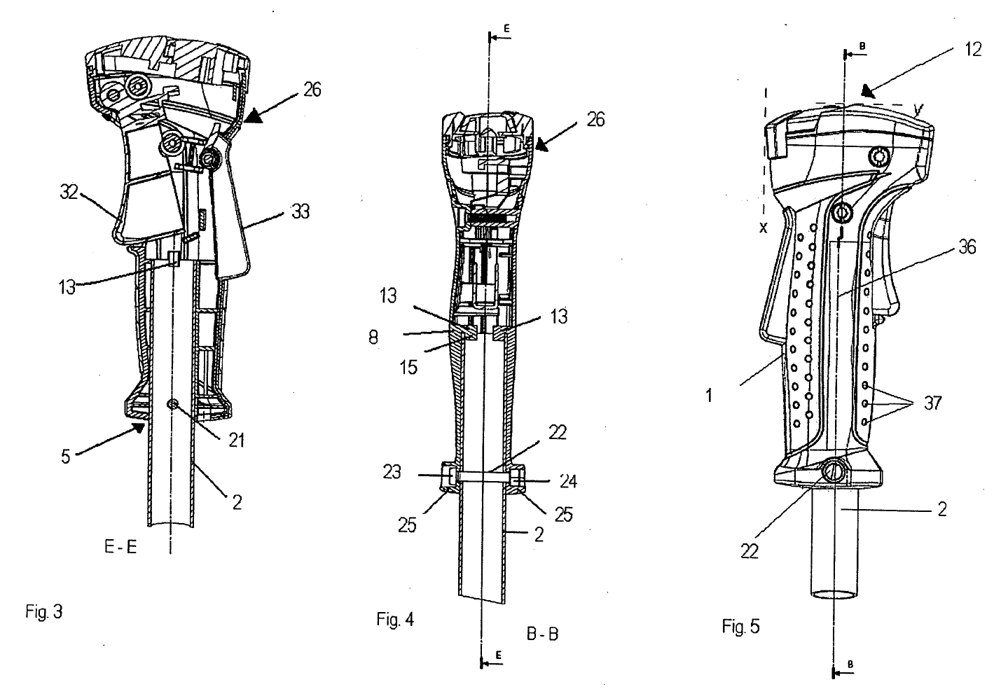

FIG. 3 a first sectional illustration E-E according to the section in FIG. 4, which shows a grip mechanism,

FIG. 4 a further sectional illustration of the grip with the mechanism,

FIG. 5 an illustration of the grip from the side,

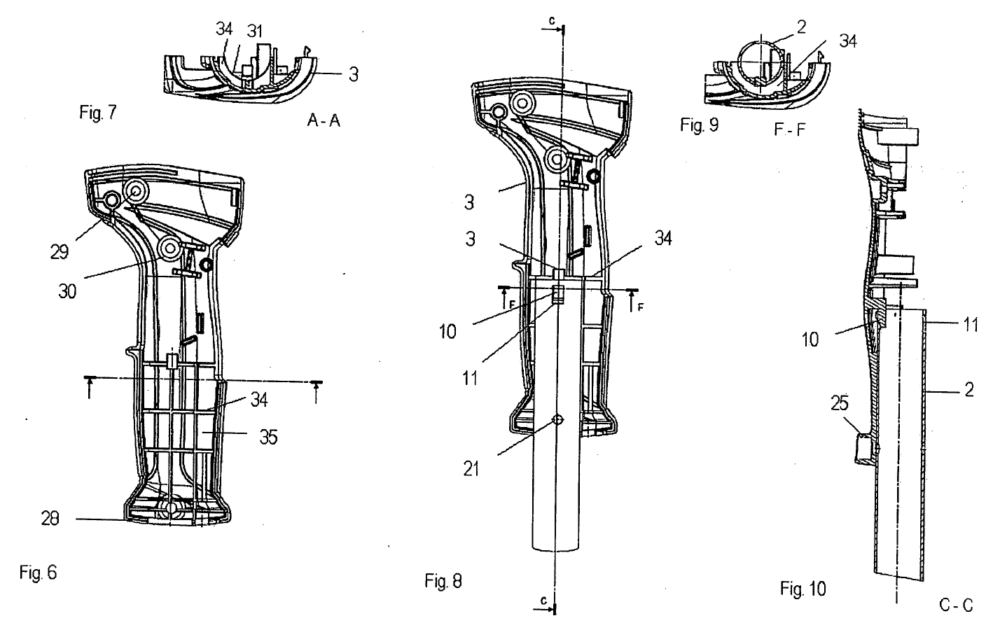

FIG. 6 an illustration of a half-shell from the interior

FIG. 7 a sectional illustration according to the line A-A in FIG. 6,

FIG. 8 an illustration of a half-shell from the interior with the tubular pipe,

FIG. 9 a sectional illustration according to the line F-F in FIG. 8,

FIG. 10 a sectional illustration according to the line C-C in FIG. 8,

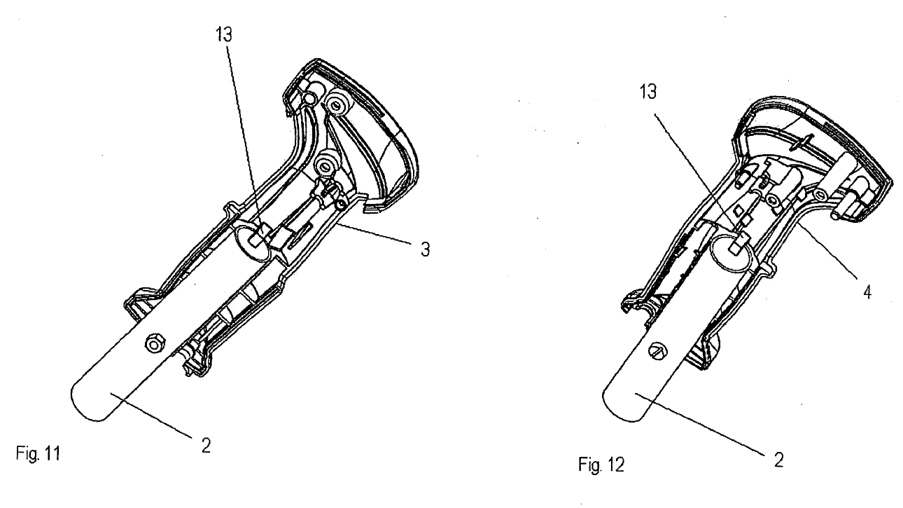

FIG. 11 a further perspective illustration of the first half-shell with a piece of tube,

FIG. 12 a further perspective illustration of the second half-shell with the piece of tube,

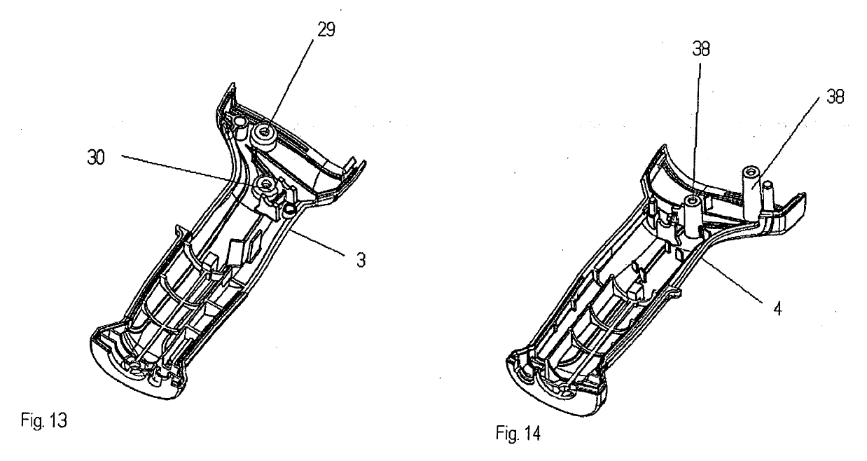

FIG. 13 a further perspective illustration of the first half-shell without the piece of tube, and

FIG. 14 a further perspective illustration of the second half-shell without the piece of tube.

In the figures, identical parts are given the same reference numbers.

FIG. 1, FIG. 2a and 2b show a hand grip 1 in section, in order to be able to better clarify its fixing on a tubular pipe 2. The hand grip 1 comprises two half-shells 3, 4. These are fastened to the tubular pipe 2. When the two half-shells 3, 4 are joined together, the hand grip 1 has a mounting opening 5, indicated in FIG. 3, for the tubular pipe 2. This is provided for a steering rod or a so-called U-handlebar of a scythe.

FIGS. 1 and 2a or 2b show the solution according to the invention, which consists in that each half-shell 3, 4 is provided with a holding arrangement corresponding to the tubular pipe 2, so that the two holding arrangements 6 form a form-fitting mounting onto the tubular pipe 2.

On the two half-shells 3, 4 respectively at least one engagement piece 7 is arranged, with only one engagement piece 7 being able to be seen in FIG. 2a. This engages into the tube interior of the tubular pipe 2. After the insertion of the tubular pipe 2 into the mounting opening 5 up to a stop 8, which is preferably formed by the engagement pieces 7, but alternatively can be produced by a shoulder or suchlike on the half-shell 3 or 4, the tubular pipe 2 is caught, as shown in FIG. 4. For this, each engagement piece 7 is constructed according to the invention as an engagement hook 13. FIG. 1 shows the pair of oppositely arranged engagement hooks 13. A detent nose 10, formed on the engagement hook 13, which is shown in FIG. 8, serves for this. This detent nose engages into a—for example rectangular—opening 11 in the tubular pipe 2. Thereby, each is constructed with engagement hooks 13 comprising a barb 15. The barb 15 engages with its detent nose 10, also shown in FIG. 10, into the tube opening 11 on the tubular pipe 2 and engages behind the tube surface. When the half-shells 3, 4 are pushed onto the tubular pipe 2 or vice versa, the engagement pieces 7 therefore engage. This creates a secure connection. In order to separate the tubular pipe 2 from the hand grip 1 again, the barbs 15 must be released mechanically from the corresponding tube opening 11.

Through this engagement, the two half-shells 3, 4 are pressed against each other. Here, a form-fitting connection is produced between the half-shells 3, 4 and with the tubular pipe 2.

The two half-shells 3, 4 can be connected with each other by means of a hinge joint which is not shown. Thus, they can be swivelled to each other and folded on each other. The hinge joint would then be arranged at the head 12 such that the swivelling movement takes place about the axis X shown in FIG. 5 or about the axis Y. The hinge joint can be constructed at this point as a film hinge. The two half-shells 3 and 4 would then be connected in one piece with each other by the film hinge and would be held undetachably.

As FIG. 2b shows, each engagement hook 13 is constructed substantially as an L-shaped shaped part 16, projecting from an inner surface of the corresponding half-shell 3, 4. In particular, it consists of two parallel L-shaped legs 17, 18, which are bridged at their end 19 with a connecting cross-piece 20. It can be seen that at the front end of the legs 17, 18 a U-section is thus produced.

In FIG. 3 and FIG. 4 or also FIG. 5, a bore 21 and a screw 22 are designated. In addition, namely in the vicinity of the mounting opening 5, the connecting screw 22 is present, connecting the two half-shells 3, 4 and projecting through the tube bore 21. As FIG. 4 or 10 show, the screw head 23 or a corresponding nut 24 in fact project out from the grip, with a dome extension 25, running around the screw head 23 or the nut 24, projecting even further outwards. In this region, however, this is no longer intrusive, because the user does not usually touch this region. It can be seen that such an outwardly projecting elevation in the region of the centre of the grip 1, at which approximately the tubular pipe 2 terminates or at a somewhat lower region, would be very intrusive.

In addition to a grip bore for the connecting screw, there can also be further bores 29, 30 in the vicinity of the head for further screws, as FIG. 6 shows.

From FIGS. 3 and 4, the grip mechanism 26, arranged in a clamping area, can be seen. This serves for operating a motor scythe or else another motor tool. The motor can be an electric motor or a combustion motor. The mechanism 26 can comprise an operating element 32, an engagement lever 33 and other mechanical components, such as traction cable, spring elements and similar. In addition, electrical or electromechanical components can also be present, such as switches, a wiring or other electronic, electrical and/or electromechanical components.

Inside each half-shell 3, 4, as for example FIG. 6 and FIG. 7 show, reinforcement ribs 34, 35 are present, which run horizontally or vertically to the tubular pipe 2. The horizontal ribs 34 are constructed with semicircular recesses 31 for guiding and holding the tubular pipe 2, as FIGS. 7 and 9 show. These ribs 34, 35 also serve as mounting ribs. On installation, the tubular pipe is pushed into the joined-together half-shells or grip shells. In this process, the ribs receive the tube.

As FIG. 5 shows for example, the grip surfaces 36 are not interrupted by openings or screws. Expediently, in the region of the grip surface 36 a knob-like structure 37 is present, in order to improve the gripping.

FIGS. 11 to 14 show the two half-shells 3 and 4 with and without tubular pipe 2.

The hand grip 1 is preferably constructed so that the connecting tube or connecting piece acting as tubular pipe 2 is connected in one piece with the steering rod of the scythe or is a part thereof. However, it is also conceivable that the connecting tube or connecting piece acting as tubular pipe 2 is constructed as a separate piece from the steering rod. The separate connecting piece can be a short pipe which is fastened to the steering rod. The separate connecting piece can, for example, be connected with the steering rod by a thread or with separate screws. Other form- and/or force-fitting connections are also possible.

In the region of the upper grip bores 29 to 30 (cf. FIG. 13, FIG. 14 and also FIG. 6) in particular dome-like screw guides 38 are provided, so that the corresponding connecting screws can be mounted in a simple manner.

### List of Reference Numbers

1 Hand grip
2 Tubular pipe
3 First half-shell
4 Second half-shell
5 Mounting opening
6 Holding arrangement
7 Engagement piece
8 Stop
9 -
10 Detent nose
11 Opening
12 Head
13 Engagement hook
14 -
15 Barb
16 Shaped part
17 First leg
18 Second leg
19 End of the legs
20 Connecting cross-piece
21 Tube bore
22 Connecting screw
23 Screw head
24 Nut
25 Dome extension
26 Grip mechanism
27 -
28 First grip bore
29 Second grip bore
30 Third grip bore
31 Recess
32 Operating element
33 Engagement lever
34 Reinforcement ribs (horizontal)
35 Reinforcement ribs (vertical)
36 Grip surfaces
37 Knob structure
38 Screw guides

1. A hand grip with half-shells is constructed so as to be able to be fastened to a tubular pipe, and is provided with a mounting opening for the tubular pipe, in particular for use for a scythe,
characterized in that:
each half-shell is provided with a holding arrangement corresponding to the tubular pipe, so that the two holding arrangements form a form-fitting mounting for the respective half-shell on the tubular pipe.

2. A hand grip according to claim 1, characterized in that on each half-shell at least one engagement piece is arranged as a respective one of the holding arrangements, which engages into the tube interior of the tubular pipe and after an insertion of the tubular pipe up to a stop is caught with the tubular pipe such that the two half-shells are pressed against each other and are connected in a form-fitting manner with the tubular pipe.

3. A hand grip according to claim 2, characterized in that on each engagement piece, constructed as an engagement hook, at least one barb is arranged, which engages into a corresponding opening in the tubular pipe and on pushing on of the half-shells onto the tubular pipe or on pushing-in of the tubular pipe onto the half-shells up to a stop is caught with the tubular pipe such that the two half-shells are pressed against each other and form a form-fitting connection.

4. A hand grip according to claim 1, characterized in that the two half-shells are connected with each other by means of a hinge joint, so that they can be swivelled to each other and folded on each other.

5. A hand grip according to claim 4, characterized in that the hinge joint is constructed as a film hinge and the two half-shells are connected with each other in one piece by the film hinge, in particular are produced from a single plastic injection process.

6. A hand grip according to claim 1, characterized in that each holding arrangement is constructed as an engagement hook comprising at least one barb, which engagement hook engages into a corresponding tube opening on the tubular pipe, such that when the half-shells are pushed onto the tubular pipe or when the tubular pipe is pushed into the half-shells these engage so that a secure connection is provided, which is only releasable when the barbs are released mechanically out of the corresponding tube opening.

7. A hand grip according to claim 6, characterized by a pair of oppositely arranged engagement hooks.

8. A hand grip according to claim 1, characterized in that each holding arrangement is constructed substantially as an L-shaped shaped part projecting from an inner surface of the corresponding half-shell.

9. A hand grip according to claim 8, characterized in that each holding arrangement consists of two parallel L-shaped legs, which are bridged at their end by a connecting cross-piece, so that at a front end of the legs a U-section is present.

10. A hand grip according to claim 9, characterized in that in the vicinity of the mounting opening and/or at a region of a head of grip at least one connecting screw is present, connecting the two half-shells and projecting through a tube bore.

11. A hand grip according to claim 10, characterized by a grip mechanism arranged in a clamping area, for operating a motor tool, in particular a motor scythe.

12. A hand grip according to claim 11, characterized by electric or electromechanical components.

13. A hand grip according to claim 12, characterized by reinforcement ribs, arranged inside each half-shell, constructed as mounting ribs, for guiding and holding the tubular pipe.

14. A hand grip according to claim 1, characterized in that the tubular pipe connecting the half-shells is a steering rod of the scythe.

15. A hand grip according to claim 14, characterized in that the tubular pipe connecting the half-shells is a connecting piece or connecting tube which is separate from a steering rod of the scythe.

16. A scythe with a hand grip according to claim 15, and with a U-shaped handlebar which comprises the tubular pipe.
